(19) United States
(12) Patent Application Publication
(10) Pub. No.: US 2021/0184195 A1
(43) Pub. Date: Jun. 17, 2021

(54) PASSIVE THERMAL SUPPRESSION MATERIAL SYSTEMS FOR BATTERY PACKS

(71) Applicant: FORD GLOBAL TECHNOLOGIES, LLC, Dearborn, MI (US)

(72) Inventors: Mohammadreza EFTEKHARI, Northville, MI (US); James Maurice BOILEAU, Novi, MI (US); Patrick Daniel MAGUIRE, Ann Arbor, MI (US)

(21) Appl. No.: 16/716,627

(22) Filed: Dec. 17, 2019

(51) Int. Cl. H01M 2/10; H01M 10/653; H01M 10/658

(52) U.S. Cl. CPC H01M 2/1094; H01M 10/658; H01M 10/653; H01M 2/1077

(57) ABSTRACT

This disclosure details exemplary battery pack designs for use in electrified vehicles. An exemplary battery pack may include a battery system and a passive thermal suppression material system positioned about at least a portion of the battery system. The passive thermal suppression material system is configured to release a thermal suppression material during certain battery thermal events. The thermal suppression material prevents or delays thermal runaway inside the battery pack.

### TECHNICAL FIELD

This disclosure relates generally to battery packs, and more particularly to battery packs that include thermal suppression material systems for preventing or delaying thermal runaway during battery thermal events.

### BACKGROUND

The desire to reduce automotive fuel consumption and emissions has been well documented. Therefore, electrified vehicles are being developed that reduce or completely eliminate reliance on internal combustion engines. In general, electrified vehicles differ from conventional motor vehicles because they are selectively driven by battery powered electric machines. Conventional motor vehicles, by contrast, rely exclusively on the internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles. The battery cells and battery internal components can experience thermal runaway during certain battery thermal events (e.g., overcharging, overheating, etc.).

### SUMMARY

A battery pack according to an exemplary aspect of the present disclosure includes, among other things, a battery system and a passive thermal suppression material system positioned about at least a portion of the battery system. The passive thermal suppression material system includes a thermal suppression sheet comprised of a first polymer film, a second polymer film, and a suppression material between the first and second polymer films.

In a further non-limiting embodiment of the foregoing battery pack, the first and second polymer films are made of a low melting point polymer.

In a further non-limiting embodiment of either of the foregoing battery packs, the low melting point polymer includes polyethylene, polypropylene, nylon, or polyethylene terephthalate.

In a further non-limiting embodiment of any of the foregoing battery packs, the suppression material includes sodium chloride-based salts.

In a further non-limiting embodiment of any of the foregoing battery packs, the suppression material includes copper-based powders.

In a further non-limiting embodiment of any of the foregoing battery packs, the suppression material includes graphite-based powders.

In a further non-limiting embodiment of any of the foregoing battery packs, the thermal suppression sheet covers a top surface of a battery array of the battery system.

In a further non-limiting embodiment of any of the foregoing battery packs, a second thermal suppression sheet covers a first side surface of the battery array, a third thermal suppression sheet covers a second side surface of the battery array, a fourth thermal suppression sheet covers a first end surface of the battery array, and a fifth thermal suppression sheet covers a second end surface of the battery array.

In a further non-limiting embodiment of any of the foregoing battery packs, the thermal suppression sheet is disposed across multiple battery arrays of the battery system.

In a further non-limiting embodiment of any of the foregoing battery packs, the suppression material is sandwiched between the first and second polymer films inside the thermal suppression sheet.

A battery pack according to another exemplary aspect of the present disclosure includes, among other things, a battery system and a passive thermal suppression material system positioned about at least a portion of the battery system. The passive thermal suppression material system includes a slip cover including a polymer film and a suppression material encapsulated inside the polymer film.

In a further non-limiting embodiment of the foregoing battery pack, the polymer film is made of a low melting point polymer.

In a further non-limiting embodiment of either of the foregoing battery packs, the low melting point polymer includes polyethylene, polypropylene, nylon, or polyethylene terephthalate.

In a further non-limiting embodiment of any of the foregoing battery packs, the suppression material includes sodium chloride-based salts.

In a further non-limiting embodiment of any of the foregoing battery packs, the suppression material includes copper-based powders.

In a further non-limiting embodiment of any of the foregoing battery packs, the suppression material includes graphite-based powders.

In a further non-limiting embodiment of any of the foregoing battery packs, the slip cover is received over a battery array of the battery system.

In a further non-limiting embodiment of any of the foregoing battery packs, a second slip cover is received over a second battery array of the battery system.

In a further non-limiting embodiment of any of the foregoing battery packs, the slip cover is received over multiple battery arrays of the battery system.

In a further non-limiting embodiment of any of the foregoing battery packs, the slip cover is receiver over a bus bar module, an ICB cover, or a battery cell holding frame of the battery system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a battery pack of an electrified vehicle.

FIGS. 3 and 4 illustrate select portions of a battery system of the battery pack of FIG. 2. An enclosure of the battery pack is removed in FIGS. 3-4 to better illustrate the components of the battery system.

FIG. 5 schematically illustrates an exemplary passive thermal suppression material system positioned relative to a battery system.

FIG. 6 schematically illustrates another exemplary passive thermal suppression material system.

FIG. 7 schematically illustrates yet another exemplary passive thermal suppression material system.

FIG. 8 illustrates a thermal suppression sheet of a passive thermal suppression material system.

FIG. 9 schematically illustrates a method of manufacturing the thermal suppression sheet of FIG. 8.

FIG. 10 schematically illustrates the functionality of a passive thermal suppression material system during a battery thermal event.

FIG. 11 illustrates another exemplary passive thermal suppression material system.

FIG. 12 illustrates another exemplary passive thermal suppression material system.

FIG. 13 illustrates yet another exemplary passive thermal suppression material system.

### DETAILED DESCRIPTION

This disclosure details exemplary battery pack designs for use in electrified vehicles. An exemplary battery pack may include a battery system and a passive thermal suppression material system positioned about at least a portion of the battery system. The passive thermal suppression material system is configured to release a thermal suppression material during certain battery thermal events. The thermal suppression material prevents or delays thermal runaway inside the battery pack. These and other features are discussed in greater detail in the following paragraphs of this detailed description.

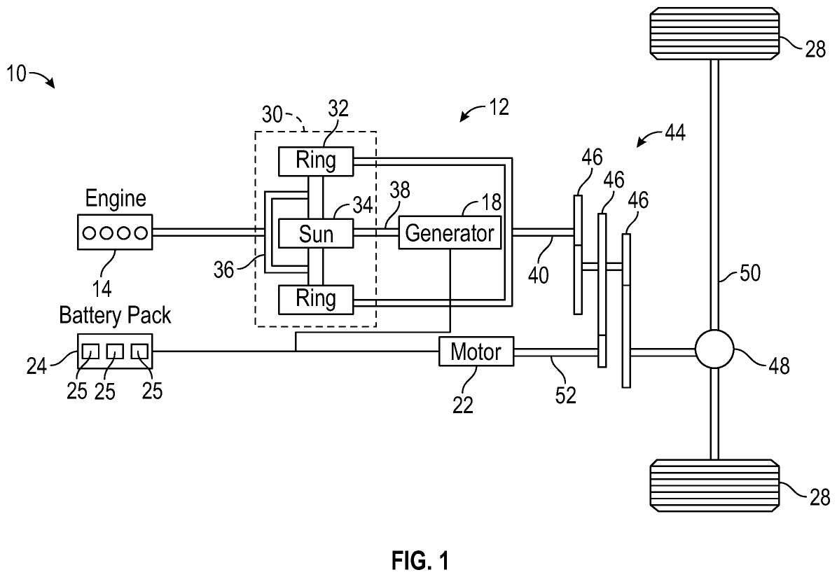

FIG. 1 schematically illustrates a powertrain 10 for an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEV's), battery electric vehicles (BEVs), fuel cell vehicles, etc.

In an embodiment, the powertrain 10 is a power-split powertrain system that employs first and second drive systems. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems are each capable of generating torque to drive one or more sets of vehicle drive wheels 28 of the electrified vehicle 12. Although a power-split configuration is depicted in FIG. 1, this disclosure extends to any hybrid or electric vehicle including full hybrids, parallel hybrids, series hybrids, mild hybrids, or micro hybrids.

The engine 14, which may be an internal combustion engine, and the generator 18 may be connected through a power transfer unit 30, such as a planetary gear set. Of course, other types of power transfer units, including other gear sets and transmissions, may be used to connect the engine 14 to the generator 18. In a non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In a non-limiting embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In a non-limiting embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an exemplary electrified vehicle battery. The battery pack 24 may be a high voltage traction battery that includes a plurality of battery arrays 25 (i.e., battery assemblies or groupings of battery cells) capable of outputting electrical power to operate the motor 22, the generator 18, and/or other electrical loads of the electrified vehicle 12 for providing power to propel the wheels 28. Other types of energy storage devices and/or output devices could also be used to electrically power the electrified vehicle 12.

In an embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

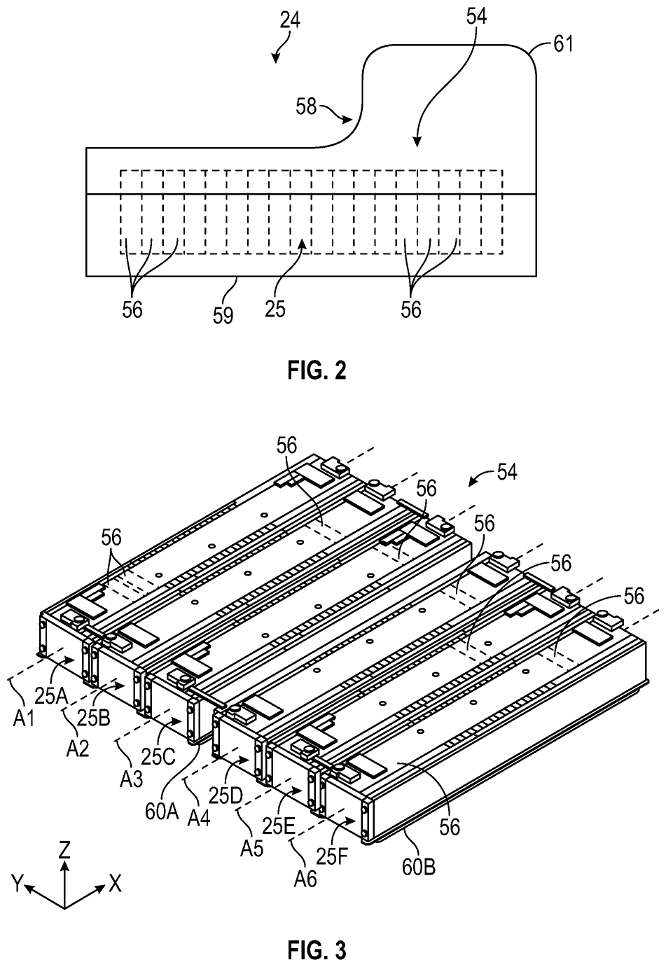

FIG. 2 schematically illustrates a battery pack 24 that can be employed within an electrified vehicle. For example, the battery pack 24 could be incorporated as part of the powertrain 10 of the electrified vehicle 12 of FIG. 1. FIG. 2 is an assembled, perspective view of the battery pack 24.

The battery pack 24 may include a battery system 54 and an enclosure assembly 58. The battery system 54 may be housed inside the enclosure assembly 58. The enclosure assembly 58 may be a sealed enclosure that includes a tray 59 and a cover 61 and may embody any size, shape, and configuration within the scope of this disclosure. For example, the enclosure assembly 58 could be rectangular, triangular, round, irregular, etc. The enclosure assembly 58 may be constructed of metallic materials, polymer-based materials, textile materials, or any combination of these materials.

The battery system 54 is shown removed from the enclosure assembly 58 in FIG. 3, which will now be described with continued reference to FIGS. 1 and 2. The battery system 54 of the battery pack 24 includes a plurality of battery cells 56 that store energy for powering various electrical loads of the electrified vehicle 12. The battery system 54 could include any number of battery cells within the scope of this disclosure. Therefore, this disclosure is not limited to the exact battery system configuration shown in FIG. 3.

The battery cells 56 may be stacked side-by-side to construct a grouping of battery cells 56, sometimes referred to as a battery array. In an embodiment, the battery cells 56 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery system 54 depicted in FIG. 3 includes a first battery array 25A, a second battery array 25B, a third battery array 25C, a fourth battery array 25D, a fifth battery array 25E, and a sixth battery array 25F. Although the battery system 54 is depicted as including six battery arrays, the battery pack 24 could include a greater or fewer number of battery arrays and still fall within the scope of this disclosure. Unless stated otherwise herein, when used without any alphabetic identifier immediately following the reference numeral, reference numeral “25” may refer to any of the battery arrays 25A-25F.

The battery cells 56 of the first battery array 25A are distributed along a first longitudinal axis A1, the battery cells 56 of the second battery array 25B are distributed along a second longitudinal axis A2, the battery cells 56 of the third battery array 25C are distributed along a third longitudinal axis A3, the battery cells 56 of the fourth battery array 25D are distributed along a fourth longitudinal axis A4, the battery cells 56 of the fifth battery array 25E are distributed along a fifth longitudinal axis A5, and the battery cells 56 of the sixth battery array 25F are distributed along a sixth longitudinal axis A6. In an embodiment, the longitudinal axes A1 through A6 are laterally spaced from and parallel to one another once the battery arrays 25 are positioned within the enclosure assembly 58.

Each battery array 25 of the battery system 54 may be positioned relative to one or more heat exchanger plates (see features 60A, 60B), sometimes referred to as cold plates or cold plate assemblies, such that the battery cells 56 are either in direct contact with or in close proximity to at least one heat exchanger plate. In an embodiment, the battery arrays 25 are positioned on top of at least one heat exchanger plate. Therefore, the heat exchanger plate at least partially supports the battery cells 56 of each battery array 25 in the Z-axis direction.

In an embodiment, the battery arrays 25A, 25B, 25C share a first heat exchanger plate 60A, and the battery arrays 25D, 25E, and 25F share a second heat exchanger plate 60B. Alternatively, each battery array 25 could be positioned relative to its own heat exchanger plate, or all battery arrays may share a single heat exchanger plate.

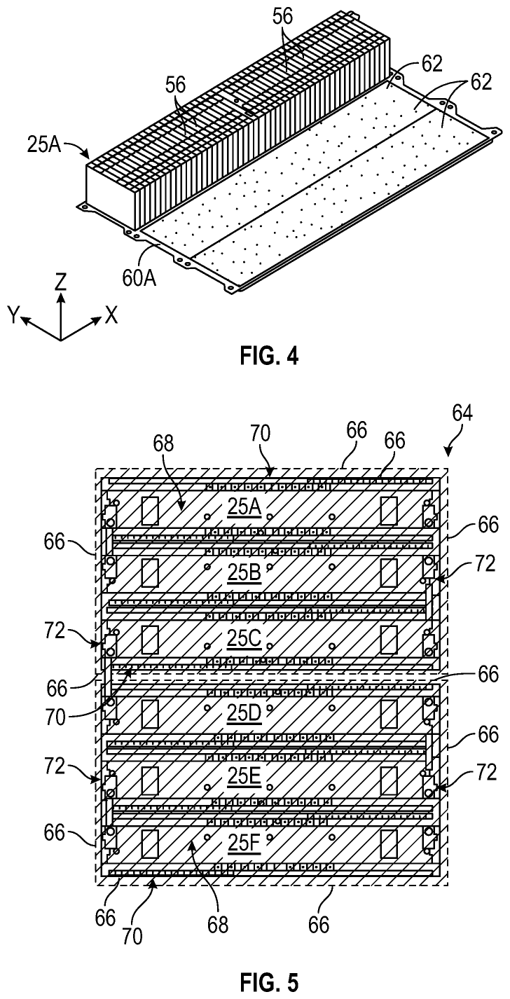

A thermal interface material (TIM) 62 (see FIG. 4) may optionally be positioned between the battery arrays 25 and the heat exchanger plates 60A, 60B such that exposed surfaces of the battery cells 56 are in direct contact with the TIM 62. The TIM 62 maintains thermal contact between the battery cells 56 and the heat exchanger plates 60A, 60B, thereby increasing the thermal conductivity between these neighboring components during heat transfer events.

The TIM 62 may be made of any known thermally conductive material. In an embodiment, the TIM 62 includes an epoxy resin. In another embodiment, the TIM 62 includes a silicone based material. Other materials, including thermal greases, may alternatively or additionally make up the TIM 62.

The heat exchanger plates 60A, 60B may be part of a liquid cooling system that is associated with the battery system 54 and is configured for thermally managing the battery cells 56 of each battery array 25. For example, heat may be generated and released by the battery cells 56 during charging operations, discharging operations, extreme ambient conditions, or other conditions. It may be desirable to remove the heat from the battery system 54 to improve capacity, life, and performance of the battery cells 56. The heat exchanger plates 60A, 60B are configured to conduct the heat out of the battery cells 56. In other words, the heat exchanger plates 60A, 60B may operate as heat sinks for removing heat from the heat sources (i.e., the battery cells 56). The heat exchanger plates 60A, 60B could alternatively be employed to heat the battery cells 56, such as during extremely cold ambient conditions.

The battery system 54 may additionally include a plurality of electrical components (not shown) that establish an electrical assembly of the battery system 54. The electrical components may include a bussed electrical center (BEC), a battery electric control module (BECM), an electrical distribution system, wiring, a plurality of input/output (I/O) connectors, etc.

The battery arrays 25 or the other battery internal components of the battery system 54 of the battery pack 24 may be susceptible to thermal runaway (i.e., thermal propagation). For example, during certain battery thermal events (e.g., overcharging, overheating, defective cell, damaged cell, etc.), the temperature of the battery cells 56 may increase until one or more of the battery cells 56 vent high temperature, pressurized gases. Flames and smoke may also be produced when battery cell temperatures exceed a threshold level, thereby rending nearby battery components, such as adjacent battery cells, susceptible to damage. This disclosure therefore proposes thermal suppression material systems that are configured to release a chemical suppressant in order to prevent or delay thermal runaway within the battery pack 24.

FIG. 5, with continued reference to FIGS. 1-4, illustrates an exemplary passive thermal suppression material system 64 for preventing or delaying thermal runaway during battery thermal events of the battery pack 24. The system 64 is considered “passive” in that the thermal suppression capabilities (i.e., via the release of chemical suppressants) of the system 64 are automatically activated in response to excessive temperature conditions (e.g., greater than about 120 degrees C./148 degrees F.) and without requiring any action by the vehicle operator.

The passive thermal suppression material system 64 may include one or more thermal suppression sheets 66 that are positioned about portions of the battery system 54. In a first embodiment, shown in FIG. 5, the thermal suppression sheets 66 are arranged to cover the tops 68, sides 70, and ends 72 of the battery arrays 25 of the battery system 54. In the illustrated embodiment, five thermal suppression sheets 66 are arranged relative to one another to cover the tops 68, sides 70, and ends 72 of the first, second, and third battery arrays 25A, 25B, 25C, and five additional thermal suppression sheets 66 are arranged relative to one another to cover the tops 68, sides 70, and ends 72 of the fourth, fifth, and sixth battery arrays 25D, 25E, 25F of the battery system 54. Other configurations are also contemplated within the scope of this disclosure.

The thermal suppression sheets 66 may be held in place with respect to the battery arrays 25 in a variety of manners. For example, the thermal suppression sheets 66 may be affixed relative to the battery arrays 25 using adhesives, adhesive tape, mechanical joints, welding, spring force, trapped in place, etc.

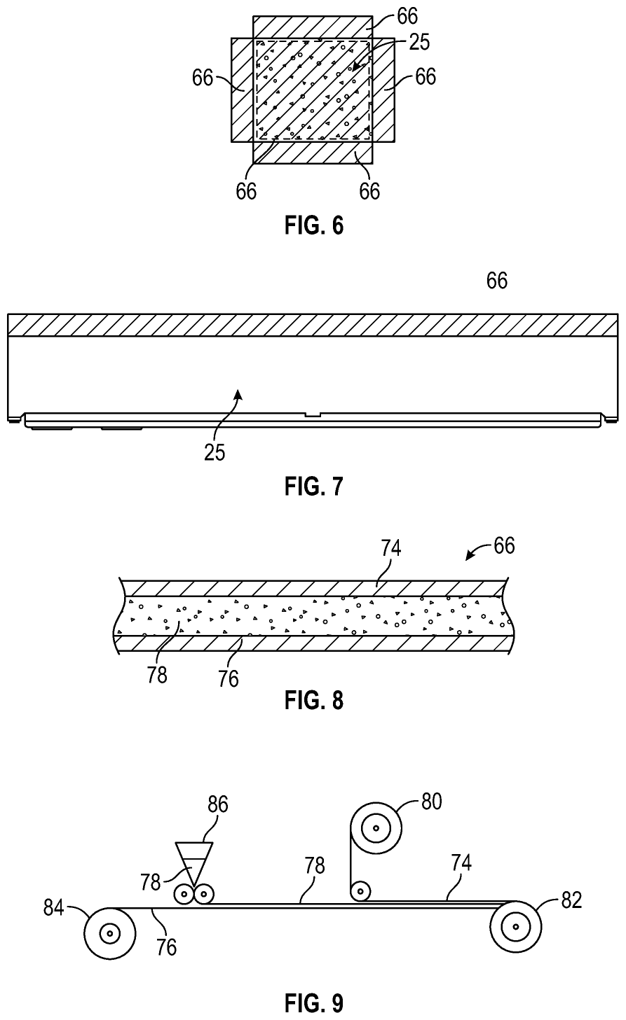

Although each thermal suppression sheet 66 is shown as spanning multiple battery arrays 25 in FIG. 5, the thermal suppression sheets 66 could alternatively be arranged about five sides of each battery array 25 (see FIG. 6). In yet another embodiment, the thermal suppression sheets 66 are disposed only over the tops 68 of the battery arrays 25 of the battery system 54 (see FIG. 7).

FIG. 8 illustrates exemplary features of a thermal suppression sheet 66 of the passive thermal suppression material system 64. It should be understood that the various features of the thermal suppression sheet 66 of FIG. 8 are not drawn to scale and that some features may be minimized or exaggerated in order to better illustrate certain characteristics.

Each thermal suppression sheet 66 may include a first or upper polymer film 74, a second or lower polymer film 76, and a suppression material 78 disposed between the first and second polymer films 74, 76. The suppression material 78 may be sandwiched between the first and second polymer films 74, 76 such that the suppression material 78 is either partially exposed or completely enclosed inside the thermal suppression sheet 66.

The first and second polymer films 74, 76 may be made from any suitable polymer having a relatively low melting point. Example low melting point polymers for constructing the first and second polymer films 74, 76 include but are not limited to polyethylene, polypropylene, nylon, and polyethylene terephthalate.

The suppression material 78 may include any Class D fire suppressant chemical or combination of chemicals. In an first embodiment, the suppression material 78 includes sodium chloride-based salts (with or without thermoplastic polymer fillers such as nylon). In a second embodiment, the suppression material 78 includes copper-based powders. In a third embodiment, the suppression material 78 includes graphite-based powders.

The thickness of each thermal suppression sheet 66 can vary depending on the application, the type of battery cell, the amount of suppression material required to prevent propagation of a thermal event, etc. The first and second polymer films 74, 76 may be thinner compared to the thickness of the suppression material 78. In an embodiment, the thickness of each of the first and second polymer films 74, 76 is in the range of about 0.25 mm (0.010 inches) to about 1 mm (0.039 inches). In this disclosure, the term “about” means that the expressed quantities or ranges need not be exact but may be approximated and/or larger or smaller, reflecting acceptable tolerances, conversion factors, measurement error, etc.

FIG. 9, with continued reference to FIGS. 1-8, schematically illustrate an exemplary method for manufacturing the thermal suppression sheet 66 discussed above. The first polymer film 74 may be held between a first roller 80 and a second roller 82, and the second polymer film 76 may be held between the second roller 82 and a third roller 84. The suppression material 78 may be held within a hopper 86. As the rollers 80, 82, 84 rotate, the suppression material 78 may be released from the hopper 86, thereby inserting a layer of the suppression material 78 between the first and second polymer films 74, 76. The multi-layered construct may then be cut into individual sheets of any size or shape in order to form the thermal suppression sheets 66. Once cut into sheets, the thermal suppression sheets 66 may be positioned as desired inside the battery pack 24 for establishing the passive thermal suppression material system 64.

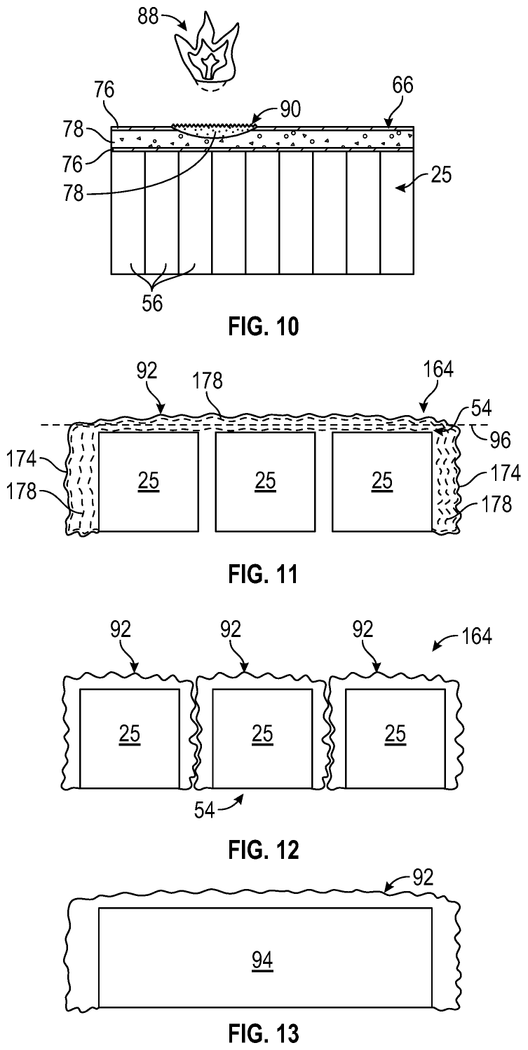

Referring to FIG. 10, the first polymer film 74 and/or the second polymer film 76 of the thermal suppression sheet 66 may melt in response to a battery thermal event in which a high heat source 88 (e.g., a damaged battery cell) is located proximate to one or more battery cells 56 of the battery arrays 25. As the first polymer film 74 and/or the second polymer film 76 melts, the suppression material 78 is released about the surrounding battery cells 56 of the battery arrays 25. The suppression material 78 may form an oxygen-excluding crust 90 over and/or around the battery cells 56, thereby blocking the battery cells 56 from the high heat source 88 and preventing or delaying the onset of thermal runaway.

FIG. 11 illustrates another exemplary passive thermal suppression material system 164 for preventing or delaying thermal runaway during battery thermal events of the battery pack 24. The passive thermal suppression material system 164 may include one or more suppression material slip covers 92 that are positioned about portions of the battery system 54. In an embodiment, each slip cover 92 may be disposed about a plurality of battery arrays 25 (see FIG. 11). In another embodiment, one slip cover 92 may be disposed about each battery array 25 of a battery system 54. In yet another embodiment, the slip cover 92 may be disposed about a battery internal component 94 (e.g., a bus bar module, an ICB cover, a battery cell holding frame, etc.) to provide thermal suppression at more directed and discrete locations inside the battery pack 24.

Each slip cover 92 of the passive thermal suppression material system 164 may include one or more polymer films 174 and a suppression material 178 encapsulated inside the polymer film 174. The slip cover 92 may be heat or vacuum shrunk to more tightly conform to the battery arrays 25/battery internal components 94. As the polymer film 174 melts during battery thermal events that exceed a threshold temperature, the suppression material 178 may be released about the battery arrays 25/battery internal components 94, thereby preventing or delaying the onset of thermal runaway inside the battery pack 24.

The suppression material 178 may be packaged at specific locations inside the polymer film 174 in order to provide a directed thermal suppression relative to the components that are covered by the slip cover 92. In an embodiment, the suppression material 178 may be disposed within an upper plane 96 of the slip cover 92. Other configurations are also contemplated within the scope of this disclosure.

The exemplary battery packs of this disclosure incorporate passive thermal suppression material systems that can automatically respond to excessive temperature conditions without any required user input. The thermal suppression material systems utilize chemical suppressants, rather than only thermal barriers, for preventing or delaying thermal runaway. The thermal suppression material systems provide reliable, relatively inexpensive, and easy to package thermal suppression designs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery pack, comprising:
a battery system; and
a passive thermal suppression material system positioned about at least a portion of the battery system,
wherein the passive thermal suppression material system includes a thermal suppression sheet comprised of a first polymer film, a second polymer film, and a suppression material between the first and second polymer films.

2. The battery pack as recited in claim 1, wherein the first and second polymer films are made of a low melting point polymer.

3. The battery pack as recited in claim 2, wherein the low melting point polymer includes polyethylene, polypropylene, nylon, or polyethylene terephthalate.

4. The battery pack as recited in claim 1, wherein the suppression material includes sodium chloride-based salts.

5. The battery pack as recited in claim 1, wherein the suppression material includes copper-based powders.

6. The battery pack as recited in claim 1, wherein the suppression material includes graphite-based powders.

7. The battery pack as recited in claim 1, wherein the thermal suppression sheet covers a top surface of a battery array of the battery system.

8. The battery pack as recited in claim 7, comprising a second thermal suppression sheet that covers a first side surface of the battery array, a third thermal suppression sheet that covers a second side surface of the battery array, a fourth thermal suppression sheet that covers a first end surface of the battery array, and a fifth thermal suppression sheet that covers a second end surface of the battery array.

9. The battery pack as recited in claim 1, wherein the thermal suppression sheet is disposed across multiple battery arrays of the battery system.

10. The battery pack as recited in claim 1, wherein the suppression material is sandwiched between the first and second polymer films inside the thermal suppression sheet.

11. A battery pack, comprising:
a battery system; and
a passive thermal suppression material system positioned about at least a portion of the battery system,
wherein the passive thermal suppression material system includes a slip cover comprised of a polymer film and a suppression material encapsulated inside the polymer film.

12. The battery pack as recited in claim 11, wherein the polymer film is made of a low melting point polymer.

13. The battery pack as recited in claim 12, wherein the low melting point polymer includes polyethylene, polypropylene, nylon, or polyethylene terephthalate.

14. The battery pack as recited in claim 11, wherein the suppression material includes sodium chloride-based salts.

15. The battery pack as recited in claim 11, wherein the suppression material includes copper-based powders.

16. The battery pack as recited in claim 11, wherein the suppression material includes graphite-based powders.

17. The battery pack as recited in claim 11, wherein the slip cover is received over a battery array of the battery system.

18. The battery pack as recited in claim 17, comprising a second slip cover received over a second battery array of the battery system.

19. The battery pack as recited in claim 11, wherein the slip cover is received o over multiple battery arrays of the battery system.

20. The battery pack as recited in claim 11, wherein the slip cover is receiver over a bus bar module, an ICB cover, or a battery cell holding frame of the battery system.
